(19) United States
(12) Patent Application Publication
(10) Pub. No.: US 2016/0309683 A1
(43) Pub. Date: Oct. 27, 2016

(54) Pet Collar and Leash Device

(71) Applicant: Harry Summers, Sedona, AZ (US)

(72) Inventor: Harry Summers, Sedona, AZ (US)

(21) Appl. No.: 14/696,988

(22) Filed: Apr. 27, 2015

(51) Int. Cl. A01K 27/00

(52) U.S. Cl. CPC A01K 27/003; A01K 27/001

(57) ABSTRACT

Disclosed is an improved pet collar and leash for discouraging pets from pulling while walking while encouraging good leash manners. In a preferred embodiment, the collar includes two terminal ends, each of the terminal ends having a ring thereon. One terminal end of the collar is threaded through the ring on the opposite terminal end so as to form a P-shape, and then it is removably connected to a leash via a connecting member. The leash includes a handle on each of its terminal ends. The handle that is closest to the collar can be used to gently pull the collar so as to quickly tighten and release the collar. The tightening and releasing motion does not harm the pet, but can be used to grab the pet's attention when providing a command.

### FIELD OF THE INVENTION

The present invention generally relates to a collar and a leash for pets. More particularly, the present invention is directed to a dog collar and leash, wherein the present invention is adapted to discourage dogs from pulling when being walked.

### BACKGROUND OF THE INVENTION

Dogs need regular walks for both exercise and mental stimulation. Many pet owners, however, dread walks because their dog actually walks them, or exhibits other bad leash manners. It can be particularly difficult for the elderly and children to walk dogs that are stubborn and that exhibit bad leash manners, as the dogs tend to pull or move quickly. Thus, many pet owners fail to walk their dogs regularly and cause the dogs to have an inactive lifestyle.

Some training collars comprise prong collars that dig into a dog's neck. The prongs are adapted to mimic the sensation of when a mother bites her pup; but the prongs can put excess pressure around the dog's neck and hurt the dog. Other training collars comprise shock collars that use electric current passing through metal contact points on the collar to give dogs a signal. This electric signal can range from a mild tickling sensation to a painful shock. When used incorrectly, existing training devices can be highly dangerous for dogs and cause serious injuries. In this regard, existing training collars are not safe to use. Therefore, there is a need in the prior art for a new and improved pet collar that is safe and easy to use and that is effective to train dogs.

### SUMMARY OF THE INVENTION

In view of the disadvantages inherent in the known types of dog collars and leashes and dog training aids now present in the prior art, the present invention provides an improved pet collar and leash wherein the same can be utilized to discourage pets from pulling away from their own owner when being walked.

In one embodiment, the present invention comprises an adjustable collar that is removably connected to a leash. The collar comprises a first end and a second end, wherein the first end comprises a ring so as to allow the second end to freely thread therethrough. The second end of the collar is removably connected to the leash via a clasp. The leash comprises a first end and a second end, wherein each of the first and second ends comprises a handle thereon.

In use, the collar is placed around a dog's neck so that the second end of the collar is biased towards the direction in which an owner of the dog is standing. For instance, if the owner is standing on the right side of the dog, the second end of the collar is biased towards the right. Additionally, the leash is positioned so that the handle on the first end of the leash is directly aligned with the back of the dog's head. In this regard, the collar and the leash do not migrate to the left or right side of the dog. The owner can primarily use the handle on the first end of the leash when walking the dog, and gently pull on the handle to quickly tighten and release the collar when giving commands. Such quick retraction on the dog's neck mimic the sensation of when a mother bites her pup to gain his or her attention.

The present invention is advantageous in that it is convenient to put on and taken off of a dog when going for a walk. Additionally, the present invention allows dog owners to train their dogs in a safe and effective manner without harming or injuring the dog. Specifically, the collar can be quickly tightened and released to grab the dog's attention so that the dog can understand the association between a given command and an action that the dog owner wants him or her to perform.

It is therefore an object of the present invention to provide a new and improved pet collar and leash that can be quickly tightened and released to mimic the sensation of when a mother bites her pup and to grab a pet's attention.

It is another object of the present invention to provide a new and improved pet collar and leash that can be quickly and easily put on and taken off of a pet.

It is still another object of the present invention to provide a new and improved pet collar and leash that does not harm a pet when worn.

A final object of the present invention to provide a new and improved pet collar and leash that may be readily fabricated from materials that permit relative economy and commensurate with durability.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts an overhead view of the present pet collar and pet leash.

FIG. 2 shows the present invention as worn on a dog while in use.

### DETAILED DESCRIPTION OF THE INVENTION

The present invention is directed towards an improved pet collar and leash that is used to discourage dogs from pulling away from the owner and exhibiting bad leash manners when walking. For purposes of clarity, and not by way of limitation, illustrative views of the present pet collar and leash are described with references made to the above-identified figures. Various modifications obvious to one skilled in the art are deemed to be within the spirit and scope of the present invention.

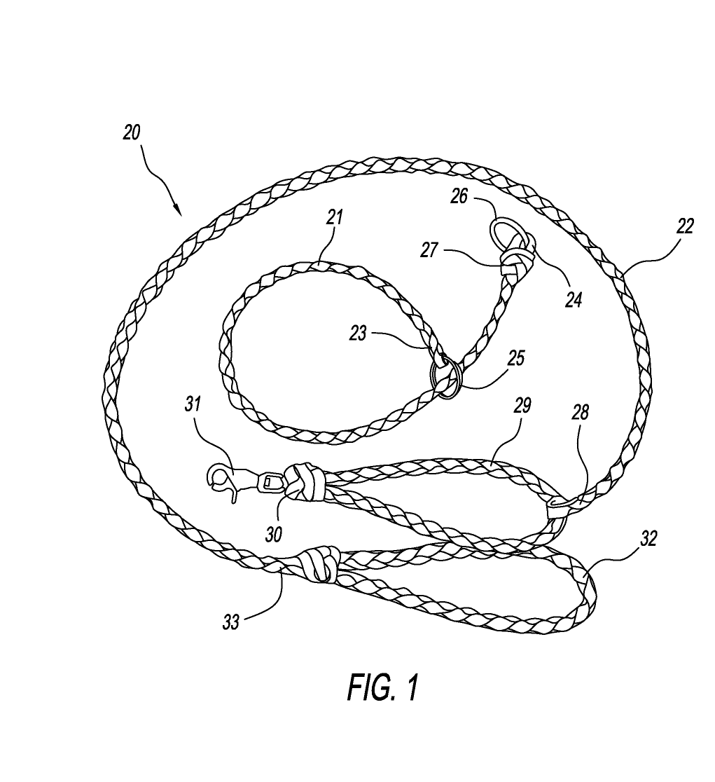

FIG. 1 shows an overhead view of the pet collar and the pet leash. The collar of the present invention 20 comprises an elongated cord 21 having a first end 23 and a second end 24. In the illustrated embodiments, the cord 21 comprises braided leather. In other embodiments, however, the cord 21 may comprise braided polypropylene, nylon, and other suitable materials. The distance between the first end 23 and the second end 24 of the cord 21 defines a length of the collar. The first end 23 of the cord 21 comprises a first ring 25 for threading the second end 24 of the cord 21 therethrough. Accordingly, the diameter of the first ring 25 is greater than the diameter of the cross section of the cord 21. The cord 21 creates a substantially P-shaped loop when viewed from the top, creating an adjustable loop for a pet to put his or her head therethrough.

The second end 24 of the cord 21 is threaded through a second ring 26 and then folded onto itself so as to create a closed loop. The second end 24 of the cord 21 may be secured in place via a reinforcement member 27. The reinforcement member 27 comprises a knot that is configured so that the second end 24 of the cord 21 does not pass back through the first ring 25. The cord 21, however, is substantially smooth in construction so as to allow the second end 24 to thread through the first ring 25 in a smooth manner without tangling.

The second ring 26 is configured to removably connect to the leash. The leash comprises an elongated cord 22 having a first end 30 and a second end 33, wherein the distance between the first end 30 and the second end 33 of the cord 22 defines a length of the leash. The length of the leash is greater than the length of the collar. Similar to the collar, the illustrated embodiment of the cord 22 comprises braided leather. In other embodiments, however, the cord 22 may comprise braided polypropylene, nylon, and other suitable materials. In the illustrated embodiments, each of the first end 30 and the second end 33 comprises a knot thereon.

The first end 30 of the leash comprises a close handle 29, which spans between the first end 30 of the leash and a joint 28 that is biased theretoward on the leash. The close handle 29 is structurally integral to the cord 22 so that the close handle 29 and the cord 22 are unitary structure. The close handle 29 is a closed loop that is dimensioned so as to allow a user to partially or entirely insert his or her hand therethrough.

The first end 30 further comprises to a connecting member 31 rotatably attached thereto. In this way, the leash does not easily tangle or twist when a dog is moving in various directions while wearing the collar. Without limitation, the connector member 31 comprises a lobster clasp, a clip clasp, and the like. The connecting member 31 is configured to removably connect to the second ring 26 of the collar. The second end 33 of the leash comprises a backup handle 32 that is structurally integral to the leash. Similar to the close handle 29, the backup handle 32 is structurally integral to the cord 22. The backup handle 32 is a closed loop that is dimensioned similarly to the close handle 29. In some embodiments, both handles 29, 32 may be ergonomically shaped so as to provide comfort to the user.

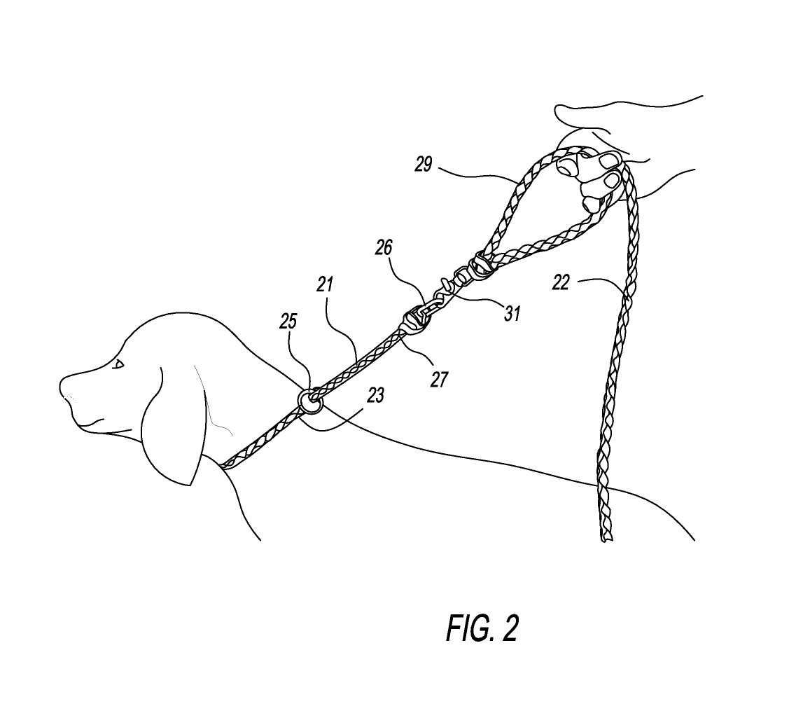

Referring now to FIG. 2, there is shown a view of the present invention in use. In use, the collar is positioned so that the cord 21 forms a substantially P-shape when viewed from the top, creating a space for a dog to place his or her head therethrough. After the cord 21 is placed through the dog's head, the second end of the cord 21 is adjusted through the first ring 25 at the first end 23 to snugly fit the cord 21 around the dog's neck. The reinforcement member 27 prevents the second end of the cord 21 from extended back through the first ring 25. Preferably, the second end of the cord 21 is extended in the direction in which the pet owner is standing. In this way, the collar does not pull across the dog, which renders the collar less effective.

The collar is positioned so that the first ring 25 is at the back of the dog's neck and the excess portion and the second end of the cord 21 extend straight back towards the dog's tail. The second ring 26 on the second end of the cord 21 is removably connected to the connecting member 31 of the leash. In this way, the leash can be disconnected from the collar when the collar is being placed around the dog's neck.

The leash is positioned so that the close handle 29 of the cord 22 is directly aligned with the back of the dog's head and colinear with the excess portion of the collar. The owner can hold the close handle 29 with the hand that is closest to the dog and hold the remaining portion of the leash with his or her other hand. Preferably, the owner can use the backup handle to ensure that he or she maintains his or her grip on the leash.

Once the collar and the leash are properly worn, the user can gently pull the leash in order to quickly tighten and loosen the collar. Tightening the collar grabs the dog's attention so that the owner can more effectively communicate with the dog when providing a command. If the owner cannot grab the dog's attention the first time, he or she can gently pull the leash the second time to quickly tighten and loosen the collar. The owner can also provide commands via verbal cues, hand signals, or other suitable means. For instance, the owner can provide commands while walking the dog to encourage good leash manners.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A pet collar and pet leash, comprising:
an adjustable collar having a first end and a second end;
said first end of said collar having a first ring;
said second end of said collar threaded through said first ring;
a leash having a first end and a second end;
said first end of said leash comprising a close handle;
said first end of said leash removably connected to said second end of said collar.

2. The pet collar and pet leash of claim 1, wherein said second end of said collar comprises a second ring.

3. The pet collar and pet leash of claim 2, wherein said first end of said leash comprises a connecting member;
said connecting member removably connected to said second ring.

4. The pet collar and pet leash of claim 3, wherein said connecting member comprises a lobster clasp.

5. The pet collar and pet leash of claim 3, wherein said connecting member is rotatably attached to said first end of said leash.

6. The pet collar and pet leash of claim 1, wherein said second end of said leash comprises a backup handle.

7. The pet collar and pet leash of claim 6, wherein said close handle and said backup handle are substantially equal in dimension and shape.

8. The pet collar and pet leash of claim 1, wherein said second end of said collar comprises a knot that is configured to prevent said second end of said collar from passing through said first ring.

9. The pet collar and pet leash of claim 1, further comprising:
a joint disposed on said leash;
said joint biased toward said first end of said leash;
a connecting member attached to said first end of said leash;
wherein said close handle spans between said connecting member and said joint.
